(19) United States
(12) Patent Application Publication
(10) Pub. No.: US 2022/0368622 A1
(43) Pub. Date: Nov. 17, 2022

(54) SYSTEMS AND METHODS FOR NETWORK OPTIMIZATION USING END USER TELEMETRY

(71) Applicant: JPMORGAN CHASE BANK, N.A., New York, NY (US)

(72) Inventors: Nick ROSENBERG, Flower Mound, TX (US); Tony M. NAZAROWSKI, Elgin, IL (US); Emily FOSTER, Houston, TX (US); Pranav RAVAL, Lake Hiawatha, NJ (US); John SMITH, New York, NY (US)

(21) Appl. No.: 17/662,749

(22) Filed: May 10, 2022

Related U.S. Application Data
(60) Provisional application No. 63/187,299, filed on May 11, 2021.

(51) Int. Cl. H04L 45/00

(52) U.S. Cl. CPC H04L 45/14; H04L 45/22; H04L 45/70

(57) ABSTRACT

Systems and methods for network optimization using end user telemetry are disclosed. In one embodiment, a method for optimizing incoming communication routing may include: (1) establishing, by a data center computer program executed by a data center computer processor, a data connection with an end user electronic device, the data connection using a first data communication route; (2) collecting, by the data center computer program, a metric for the data connection; (3) determining, by the data center computer program, that the metric is outside of an acceptable range; (4) determining, by the data center computer program, that a cause for the metric being outside of the acceptable range is external to the data center; and (5) re-routing, by the data center computer program, the data connection to a second data communication route.

### RELATED APPLICATIONS

This application claims priority to, and the benefit of, U.S. Provisional Patent Application Ser. No. 63/187,299, filed May 11, 2021, the disclosure of which is hereby incorporated, by reference, in its entirety.

### BACKGROUND OF THE INVENTION

### 1. Field of the Invention

Embodiments relate generally to systems and methods for network optimization using end user telemetry.

### 2. Description of the Related Art

When employees work from home, they typically use their own Internet Service Provider (ISP) and connect through a Virtual Private Network (VPN) to access company assets. In this environment, the corporate IT department has no control of, and limited or no visibility into, multiple aspects of the end-to-end network journey for its end user.

One of the most reliable indicators end user experience is network latency, specifically the Round-Trip Time (RTT). This measure is especially important for systems such as Virtual Desktop Infrastructure (VDI), IP telephony, and video telepresence systems where even slight delays, or fluctuations, with network latency can be noticeable to the end user. The term RTT is generally accepted as the amount of cumulative time it takes for a network packet to: (1) travel from a local endpoint (e.g., an employee computer PC) to a remote endpoint (e.g., a company server); (2) be processed by the remote endpoint; and (3) travel from the remote endpoint back to the local endpoint.

Low and consistent latency is always better for a desirable user experience. While specific performance thresholds are debatable, sentiment among product engineers for VDI and video telepresence products is that 100 milliseconds (ins) or less correlates to a good user experience and 200 ms is the threshold at which service degradation starts to become noticeable. Beyond 200 ms VDI users will typically notice what is described as “keyboard lag.” Users will observe a noticeable pause from the time they type characters on their keyboard to the time the remote VDI system responds to their keystrokes. Users of video telepresence systems will start to notice video delays one their screen and audially hear a degradation of audio fidelity when other participants speak.

### SUMMARY OF THE INVENTION

Systems and methods for network optimization using end user telemetry are disclosed. In one embodiment, a method for optimizing incoming communication routing may include: (1) establishing, by a data center computer program executed by a data center computer processor, a data connection with an end user electronic device, the data connection using a first data communication route; (2) collecting, by the data center computer program, a metric for the data connection; (3) determining, by the data center computer program, that the metric is outside of an acceptable range; (4) determining, by the data center computer program, that a cause for the metric being outside of the acceptable range is external to the data center; and (5) re-routing, by the data center computer program, the data connection to a second data communication route.

In one embodiment, the first data communication route may include an end user Internet Service Provider (ISP), the Internet, and a data center ISP.

In one embodiment, the metric may include one or more of round-trip time, jitter, packet loss, and retransmission rate.

In one embodiment, the metric may be checked at an end user side and a data center side of the first data communication route.

In one embodiment, the end user electronic device may execute a thin client computer program that communicates with the data center computer program. In one embodiment, the metric may include an end user electronic device including one or more of central processing unit (CPU) usage, memory usage, storage usage, and network usage.

In one embodiment, the acceptable range may be based on an industry standard, feedback from the end user electronic device, etc.

In one embodiment, the method may also include determining, by the data center computer program, that a plurality of end users using the end user ISP have metrics outside of the acceptable range; wherein the second data communication route does not include the end user ISP.

In one embodiment, the method may also include restricting, by the data center computer program, non-essential data from being communicated to and from the end user electronic device. The non-essential data may include, for example, streaming video data.

According to another embodiment, a method for optimized routing of data to end users may include: (1) establishing, by a data center computer program executed by a data center computer processor, a data connection with a first end user electronic device associated with a first end user, the data connection using a first data communication route; (2) receiving, by the data center computer program, a latency-sensitive communication for the first end user electronic device; (3) collecting, by the data center computer program, a metric for the data connection; (4) determining, by the data center computer program, that the metric is outside of an acceptable range; (5) identifying, a second end user associated with a second end user electronic device to receive the latency-sensitive communication; and (6) routing, by the data connection computer program, the latency-sensitive communication to the second end user electronic device.

In one embodiment, the latency-sensitive communication may include streaming video data and/or streaming audio data.

In one embodiment, the metric may be one or more of round-trip time, jitter, packet loss, and retransmission rate.

In one embodiment, the second end user electronic device may be associated with a second data communication route, wherein the first data communication route comprise a first Internet Service Provider (ISP) and the second data communication route comprise as a second ISP that is different from the first ISP.

According to another embodiment, a method for detecting computer network fraud may include: (1) establishing, by a data center computer program executed by a data center computer processor, a data connection with an end user electronic device associated with an end user; (2) identifying, by the data center computer program, an Internet Protocol (IP) address for the end user electronic device; (3) retrieving, by the data center computer program, additional data based on the IP address and an identification of the end user, wherein the additional data comprises a physical location of the end user based on the IP address, a home address for the end user and a work address for the end user from a directory; (4) enriching, by the data center computer program, the IP address with the additional data; (5) detecting, by the data center computer program, an anomaly between the physical location for the end user electronic device and the home address for the end user and the work address for the user; and (6) initiating, by the data center computer program, an additional authentication requirement from the end user before allowing the data connection to continue.

In one embodiment, the additional data may also include an address from a historical travel pattern for the end user, and the data center computer program detects an anomaly between the physical location for the end user electronic device and the home address for the end user, the work address for the user, and an address from the historical travel pattern.

In one embodiment, the data center computer program may also retrieve a historical application usage pattern for the end user, and the data center computer program further detects an anomaly between an application being accessed by the end user and the historical application usage pattern.

In one embodiment, the data center computer program may also retrieve an identification of authorized applications for the end user, and the data center computer program further detects an anomaly between an application being accessed by the end user and the authorized applications.

In one embodiment, the additional authentication requirement may include multi-factor authentication.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for network optimization using end user telemetry according to an embodiment;

FIG. 2 depicts a method for network optimization using end user telemetry according to one embodiment;

FIG. 3 depicts a method for network optimization using end user telemetry according to another embodiment;

FIG. 4 depicts a method for computer network fraud detection according to another embodiment.

### DETAILED DESCRIPTION OF PREFERRED EMBODIMENTS

Systems and methods for network optimization using end user telemetry are disclosed. While embodiments may describe the use of latency, it should be recognized that any of latency, jitter, data transfer rate, and packet loss, and any combination of two or more of the preceding, may be used.

The biggest predictor of Round-Trip Time (RTT) is the physical distance between endpoints. As the propagation of network traffic is constrained by the speed of light, the health of a network path may be assessed by comparing the average RTT against known good values for two known locations. As an example, typical RTT between New York and Chicago is around 25 ms, and the RTT between Dallas and New York is about 45 ms. If telemetry measures indicate that average values (across many users) significantly deviate from these “known good” values, it very probable that end users are experiencing degraded service and that further investigation is warranted. Deviations in RTT may indicate problems such as: performance or application issues on the local endpoint (e.g., users PCs are running at 100% Central Processing Unit (CPU) capacity); problems with networking connections and/or devices within the local building (e.g., bad cables, switch or router problems in a corporate location, etc.); problems with the Wide Area Network (WAN) circuit connecting remote locations; inefficient routes where the network is successfully moving traffic but users are taking unnecessarily long routes to connect with remote endpoints, problems with network connections and/or devices within company data centers, distressed endpoints users are connecting to (e.g., VDI server running at 100% CPU capacity), etc.

As another example, over the span of 24 hours, the average latency of may be 85 ms, but this may not tell the complete story. While the average may be 85 ms over the past 24 hours, there may several data points of over 500 ms latency clustered together during the middle of the day that caused temporary VDI delays. Thus, embodiments may track the number of instances of “latency spikes.” The average numbers may be used detect large scale issues, and the spike counts may be used when investigating into individual user issues.

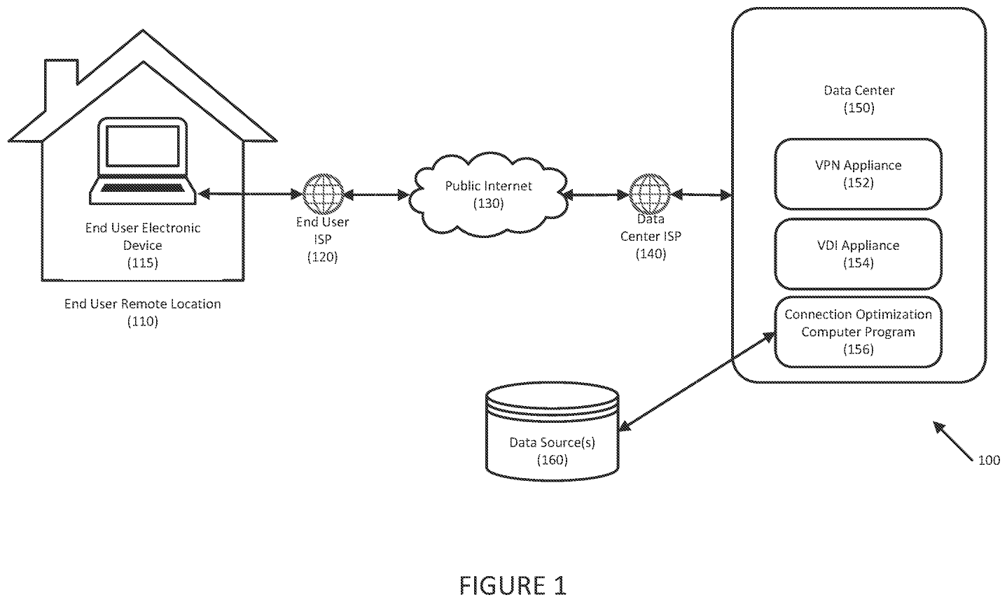

FIG. 1 depicts a high-level view of a system for network optimization using end user telemetry according to an embodiment. System 100 depicts an end-to-end network journey a company typically can observe and measure, as well as parts that are beyond their purview. System 100 depicts the common connection points used for an end user connecting to VDI appliance 154 from end user electronic device 115, such as a personal computer (PC), laptop, etc. In this example, the end user uses electronic device 115 that connects a network gateway (e.g., router and modem) in end user remote location, such as the end user's home.

From end user remote location 110, the end user's network connection travels through end user Internet Service Provider (ISP) 120, over public internet 130, through data center ISP 140, and then into data center 150 where a connection with Virtual Private Network (VPN) appliance 152 is established. The connection provided by ISP 120, public Internet 130, and data center ISP 140 may be considered to be a data communication route.

The segments between end user ISP 120 and VPN appliance 152 are subject to the variability of end user ISP 120, public internet 130, and data center ISP 140. Once connected to VPN appliance 152, the end user's connection will typically pass through one or more network firewall appliances (not shown) before ultimately connecting to an asset, such as VDI appliance 154. In most cases, the data center has precise visibility into the performance of all network segments between the ingress point into data center 150 (typically a firewall and/or VPN appliance) and the user's VDI session where the connection terminates.

When troubleshooting issues, corporations can diagnose network performance and availability issues within their data centers (e.g., data center 150), but lack the telemetry to investigate what is referred to as the “last mile” of the network segment, which is essentially everything between end user remote location 110 and the egress point of data center 150. For example, connection optimization computer program 156 executed in data center 150 may monitor data connections between data center 150 and end user electronic devices 115, and may make routing decisions. In addition, connection optimization computer program 156 may further route communications to different end user computing devices 115 depending on the quality of the data connection.

In one embodiment, connection optimization computer program 156 may interface with one or more data sources 160 and may receive data that may be used to enrich end user data. For example, data source(s) 160 may be internal data sources (e.g., company directories), external data sources (e.g., services that provide data on ISP outages in areas (“down detectors”), ISP statuses, etc.) The data from data source(s) 160 may be used to enrich information related to end user electronic device 115's connection. For example, the end user's IP address may be used to determine a general location of end user remote location 110, and then data from a down detector or similar service may be used to determine if end user remote location 110 is likely impacted by an ISP outage. Similarly, the end user's IP address may be used to identify end user ISP 120 and/or data center ISP 140, and connection optimization computer program 156 may interface with end user ISP 120 and/or data center ISP 140 directly to determine if there are any outages.

In one embodiment, data source(s) 160 may provide information regarding known or anticipated travel for end user, travel patterns for the end user, historical application usage for the end user, expected application usage for the end user, etc., and may use at least some of this data to determine whether a connection is potentially fraudulent. For example, connection optimization computer program 156 may reject a connection, or require additional authentication, in response to a “impossible travel” scenario, such as a first connection in Seattle and a second connection in London 10 minutes later. As another example, a connection may be rejected if from a restricted area (e.g., North Korea). As yet another example, a connection may be rejected, or additional authentication required, if the connection time, location, or applications that are being accessed are inconsistent with the end user's usage patterns (e.g., a software developer accessing financial records).

In one embodiment, connection optimization computer program 156 may use the end user's connection patterns to identity trends and identify employees that are at-risk for burnout based on hours worked, time of day worked, etc. In one embodiment, such employees may present a security risk, may make bad decisions, may be more likely to be involved in illicit activities, etc. and additional authentication may be required for certain decisions (e.g., financial trades)

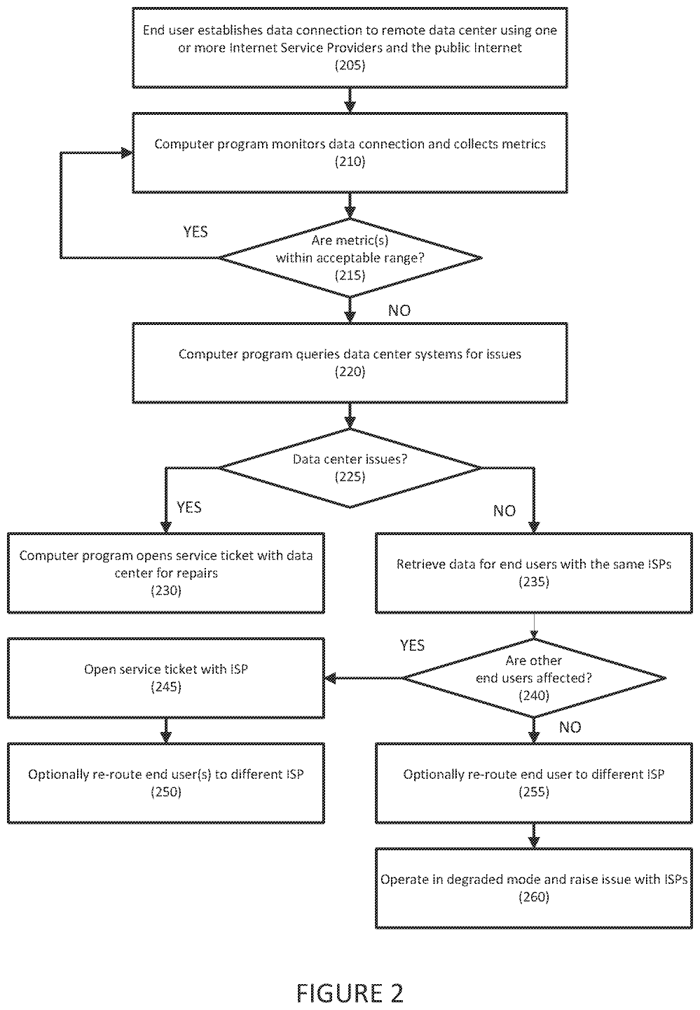

Referring to FIG. 2, a method for optimizing incoming routing is provided according to one embodiment.

In step 205, using a computer, an end user may establish a data connection to a remote data center using, for example, an end user internet service provider, the public Internet, and a data center internet service provider. In one embodiment, the end user may be an employee, and the data center may be a data center for the end user's employer.

In step 210, a computer program executed in the data center may monitor the data connection and collect metrics for the data connection, such as RTT, jitter, packet loss, retransmissions, etc. For example, the computer program may determine the RTT between the data center and the end user computer, including the time to process the packet by the remote endpoint. The computer program may also determine the jitter—the degree of variation in latency. The computer program may also determine the packet loss, such as the loss of packets between the two endpoints, that is often measured as a percentage. The computer program may also determine retransmissions, such as when one endpoint requests the other endpoint to resend a packet based on packet loss. Any other metrics may be collected as may be necessary and/or desired.

In step 215, the computer program may determine if one or more of the metrics are within an acceptable range. In one embodiment, the acceptable range may depend on, for example, the type of connection (e.g., VDI, audio, video, text, etc.) and the distance between the data center and the end user computer.

In one embodiment, the metrics may be checked on both sides, such as the end user side and the data center side. For example, the end user electronic device may execute a thin client that may check for metrics (e.g., (CPU usage, memory usage, storage, network usage, etc.) to identify any issues with resource consumption. Embodiments may also check for network health, particularly network retransmissions. Embodiments may also check for metrics on the data center side to identify any issues with resource consumption.

For example, the acceptable ranges for the metrics may be based on industry standards, historical data, end user feedback, etc. In one embodiment, the upper limit on the range may be determined using machine learning based on user feedback.

In one embodiment, the metrics may be collected and measured at any suitable interval. The metrics may then be averaged.

In another embodiment, any spikes in the metrics (e.g., a high RTT lasting longer than a certain period of time) may be identified, even though the average RTT for the period may still be within the acceptable range.

If the metric(s) are within an acceptable range, no additional actions may be taken, and the monitoring may continue in step 210.

If the metrics are not within the acceptable range, in step 220, the computer program may determine whether the delay is internal to the data center. For example, the computer program may query data center systems for any issues within the data center. In one embodiment, the computer program may query a data lake. For example, data from the data center may be provided to a data lake, and the data may then be drawn from the data lake

If, in step 225, there are data center issues, in step 230, the computer program may open a service ticket with the data center for repairs, additional attention, etc.

In one embodiment, the computer program may initiate a more thorough health check within the data center. For example, if the end user is working on an overloaded system in the data center, the computer program may move the end user to a different system.

If, in step 225, there are no data center issues, in step 235, the computer program may retrieve data from other data sources (e.g., internal and/or external data sources) to determine if the issue is affecting more than one end user. For example, the computer program may retrieve data for end users that use the same ISP to see if any other end uses are experiencing the same issue. The computer program may retrieve data from a down detector service, may identify end users with the same ISP and may collect their metrics, may retrieve data from the ISP, etc.

If, in step 240, the other end users are affected, in step 245, the computer program may open a service ticket with the ISP and, in step 250, may optionally route the end users to a different ISP, etc.

If the other end users are not affected, in step 255, the computer program may re-route the data connection and collect metrics for the new data connection.

Alternatively, or in addition, in one embodiment, the computer program may open a service ticket with the end user's ISP.

In one embodiment, the computer program may retrieve metrics (e.g., CPU usage, memory usage, network usage, etc.) from a thin client on the end user electronic device. Based on the metrics, the computer program may take any suitable remote action(s) such as closing open programs, reducing CPU usage, etc.

In one embodiment, the computer program cause self-help remedies to be displayed on the end user computer device, such as restarting the end user's router, switching to a wired connection, etc.

In step 260, the computer program may allow operation in a degraded mode by, for example, restricting the amount of non-essential data (e.g., graphics, sounds, etc.) to be communicated to the end user's electronic device. For example, an end user may drop video capabilities and may communicate by audio only. As another example, a video refresh rate may be decreased, resolution may be decreased, the number of colors displayed may be decreased, etc.

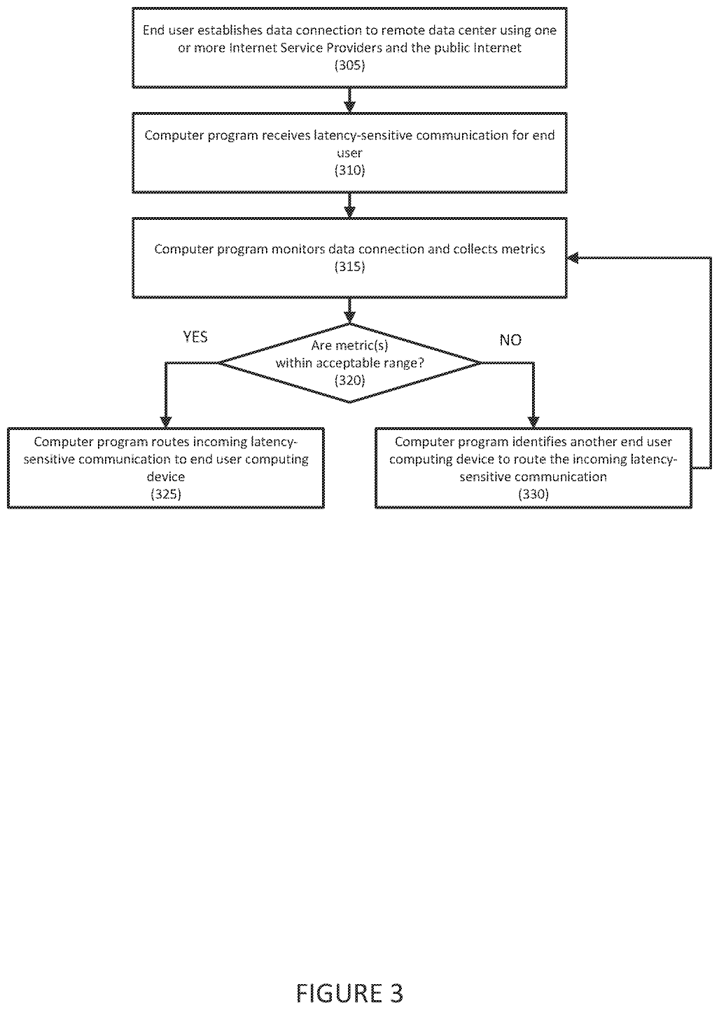

Referring to FIG. 3, a method for optimized routing to end users is provided according to one embodiment. In step 305, an end user may establish a data connection to remote data center using one or more internet service providers and the public Internet. This may be similar to step 205, above.

In step 310, a computer program executed at the data center may receive a latency-sensitive communication for the end user. Examples of latency-sensitive communications include streaming video data, streaming audio data, certain virtual desktop data, etc.

In step 315, the computer program may monitor the data connection and collect metrics for the data connection. This may be similar to step 210, above.

In step 320, the computer program may determine if one or more of the metrics are within an acceptable range. This may be similar to step 215, above. If the metrics are within the acceptable range, in step 325, the computer program may route the incoming latency-sensitive communication to the end user computing device. If the metrics are not within the acceptable range, in step 330, the computer program may identify another end user computing device to route the incoming latency-sensitive communication to, and the process may continue with step 315.

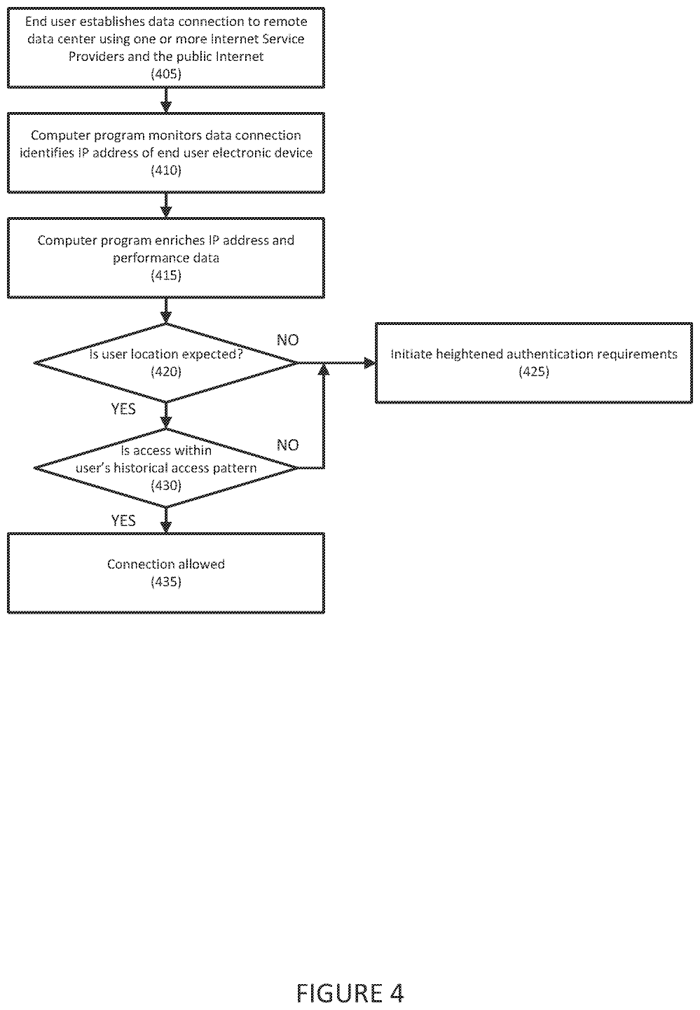

Referring to FIG. 4, a method for computer network fraud detection is provided according to an embodiment.

In step 405, an end user may establish a data connection to a remote data center using one or more internet service providers and the public Internet. This may be similar to step 205, above.

In step 410, a computer program executed at, for example, a data center, may monitor the data connection identifies the IP address of end user electronic device

In step 415, the computer program may enrich IP address and performance data with additional data. For example, the computer program may retrieve data to identify a location for the end user, an ISP for the end user, etc.

In addition, the computer program may retrieve a company directory, end user historical access data, end user historical application usage data, end user historical travel data, etc.

In step 420, the computer program may compare the location based on the IP address to the end user's home address, work address, or historical address data to determine if there is an anomaly. If there is, in step 425, the computer program may initiate heightened authentication requirements. such as requiring multi-factor authentication. If the heightened access requirements fail, the connection may be terminated.

In step 430, the computer program may compare the end user's current access to the end user's historical access pattern (e.g., location, impossible travel scenarios, end user device, time of day, applications being accessed, etc.) for anomalies. If there is an anomaly, in step 425, the computer program may initiate heightened authentication requirements. such as requiring multi-factor authentication. If the heightened access requirements fail, the connection may be terminated.

In one embodiment, out of band verification may be used, such as an automated or manual phone call to the end user, a text message, etc. to verify the end user's location, etc. In one embodiment, if the end user is sharing the end user's location, the end user's location may be automatically verified.

In one embodiment, until the end user is verified, access to systems in the data center, other protected resources, etc. may be prohibited or limited.

In step 435, the connection may be allowed.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize any suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. As an example, an Application Programmable Interface (API) may be used. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for optimizing incoming communication routing, comprising:
establishing, by a data center computer program executed by a data center computer processor, a data connection with an end user electronic device, the data connection using a first data communication route;
collecting, by the data center computer program, a metric for the data connection;
determining, by the data center computer program, that the metric is outside of an acceptable range;
determining, by the data center computer program, that a cause for the metric being outside of the acceptable range is external to the data center; and
re-routing, by the data center computer program, the data connection to a second data communication route.

2. The method of claim 1, wherein the first data communication route comprises an end user Internet Service Provider (ISP), the Internet, and a data center ISP.

3. The method of claim 1, wherein the metric comprises one or more of round-trip time, jitter, packet loss, and retransmission rate.

4. The method of claim 1, wherein the metric is checked at an end user side and a data center side of the first data communication route.

5. The method of claim 4, wherein the end user electronic device executes a thin client computer program that communicates with the data center computer program.

6. The method of claim 5 wherein the metric comprises an end user electronic device including one or more of central processing unit (CPU) usage, memory usage, storage usage, and network usage.

7. The method of claim 1, wherein the acceptable range is based on an industry standard.

8. The method of claim 1, wherein the acceptable range is based on feedback from the end user electronic device.

9. The method of claim 2, further comprising:
determining, by the data center computer program, that a plurality of end users using the end user ISP have metrics outside of the acceptable range;
wherein the second data communication route does not include the end user ISP.

10. The method of claim 1, further comprising:
restricting, by the data center computer program, non-essential data from being communicated to and from the end user electronic device.

11. The method of claim 1, wherein the non-essential data comprises streaming video data.

12. A method for optimized routing of data to end users, comprising:
establishing, by a data center computer program executed by a data center computer processor, a data connection with a first end user electronic device associated with a first end user, the data connection using a first data communication route;
receiving, by the data center computer program, a latency-sensitive communication for the first end user electronic device;
collecting, by the data center computer program, a metric for the data connection;
determining, by the data center computer program, that the metric is outside of an acceptable range;
identifying, a second end user associated with a second end user electronic device to receive the latency-sensitive communication; and
routing, by the data connection computer program, the latency-sensitive communication to the second end user electronic device.

13. The method of claim 12, wherein the latency-sensitive communication comprises streaming video data and/or streaming audio data.

14. The method of claim 12, wherein the metric comprises one or more of round-trip time, jitter, packet loss, and retransmission rate.

15. The method of claim 12, wherein the second end user electronic device is associated with a second data communication route, wherein the first data communication route comprise a first Internet Service Provider (ISP) and the second data communication route comprise as a second ISP that is different from the first ISP.

16. A method for detecting computer network fraud, comprising:
establishing, by a data center computer program executed by a data center computer processor, a data connection with an end user electronic device associated with an end user;
identifying, by the data center computer program, an Internet Protocol (IP) address for the end user electronic device;
retrieving, by the data center computer program, additional data based on the IP address and an identification of the end user, wherein the additional data comprises a physical location of the end user based on the IP address, a home address for the end user and a work address for the end user from a directory;
enriching, by the data center computer program, the IP address with the additional data;
detecting, by the data center computer program, an anomaly between the physical location for the end user electronic device and the home address for the end user and the work address for the user; and
initiating, by the data center computer program, an additional authentication requirement from the end user before allowing the data connection to continue.

17. The method of claim 16, wherein the additional data further comprises an address from a historical travel pattern for the end user, and the data center computer program detects an anomaly between the physical location for the end user electronic device and the home address for the end user, the work address for the user, and an address from the historical travel pattern.

18. The method of claim 16, wherein the data center computer program further retrieves a historical application usage pattern for the end user, and the data center computer program further detects an anomaly between an application being accessed by the end user and the historical application usage pattern.

19. The method of claim 16, wherein the data center computer program further retrieves an identification of authorized applications for the end user, and the data center computer program further detects an anomaly between an application being accessed by the end user and the authorized applications.

20. The method of claim 16, wherein the additional authentication requirement comprise multi-factor authentication.
